(19) United States
(12) Patent Application Publication
(10) Pub. No.: US 2019/0259995 A1
(43) Pub. Date: Aug. 22, 2019

(54) Assembled Battery

(71) Applicant: Calsonic Kansei Corporation, Saitama-shi, Saitama (JP)

(72) Inventors: Toshiyuki Motohashi, Saitama (JP); Yoshikazu Takamatsu, Saitama (JP); Takayuki Hirase, Saitama (JP)

(21) Appl. No.: 16/341,229

(22) PCT Filed: Oct. 10, 2017
(86) PCT No.: PCT/JP2017/036644

§ 371 Date: Apr. 11, 2019

(30) Foreign Application Priority Data
Oct. 13, 2016 (JP) 2016-202059

(51) Int. Cl. H01M 2/10

(52) U.S. Cl. CPC H01M 2/1077; H01M 2220/20; H01M 2/1094

(57) ABSTRACT

An assembled battery comprises: a plurality of battery cells; a housing having a plurality of first housing spaces for housing one end side of the plurality of battery cells and a plurality of second housing spaces for housing an other end side of the plurality of battery cells, and holding the plurality of battery cells; an adhesive portion in contact with the plurality of battery cells and the housing, and adhering the plurality of battery cells to the housing; and an insulation sheet located between the plurality of battery cells, wherein the housing includes a first frame body defining the plurality of first housing spaces and a second frame body defining the plurality of second housing spaces, and the insulation sheet is interposed between the first frame body and the second frame body, and is in contact with the adhesive portion.

### CROSS REFERENCE TO RELATED APPLICATION

The present application claims priority to Japanese Patent Application No. 2016-202059 filed with the Japan Patent Office on Oct. 13, 2016, all the contents of which are hereby incorporated by reference.

### TECHNICAL FIELD

The present disclosure relates to an assembled battery.

### BACKGROUND

An assembled battery in which a plurality of battery cells are housed in a member such as a casing is conventionally known. For example, JP 2016-66451 A discloses an assembled battery in which battery cells are housed in housing holes of a block and adhered to the inner walls of the housing hole using an adhesive. The battery cells described in JP 2016-66451 A each include a battery body and a halon tube as an exterior film covering the battery body.

### SUMMARY

An assembled battery including a plurality of battery cells is required to have insulation property between the plurality of battery cells in order to prevent a short circuit between the battery cells. In such a case, a structure of covering each battery cell with an exterior film may be used, as in the battery cells in JP 2016-66451 A.

We conceived a structure of interposing an insulation sheet between the battery cells, instead of the exterior film or in addition to the exterior film to further improve the insulation property. However, we recognized that, in the structure of locating the insulation sheet between the battery cells, unless the insulation sheet is fixed in place, the insulation sheet can move between the battery cells due to, for example, vibration during running of a vehicle on which the assembled battery is mounted and cause abnormal noise. As a result of extensive studies, we invented an assembled battery in which an insulation sheet between a plurality of battery cells can be easily fixed in place.

It could be helpful to provide an assembled battery in which an insulation sheet between a plurality of battery cells can be easily fixed in place.

An assembled battery according to a first aspect of the present disclosure comprises: a plurality of battery cells; a housing for holding the plurality of battery cells, the housing having a plurality of first housing spaces for housing one end side of the plurality of battery cells and a plurality of second housing spaces for housing an other end side of the plurality of battery cells; an adhesive portion being in contact with the plurality of battery cells and the housing, for adhering the plurality of battery cells to the housing; and an insulation sheet located between the plurality of battery cells, wherein the housing includes a first frame body defining the plurality of first housing spaces and a second frame body defining the plurality of second housing spaces, and the insulation sheet is interposed between the first frame body and the second frame body, and is in contact with the adhesive portion.

It is thus possible to provide an assembled battery in which an insulation sheet between a plurality of battery cells can be easily fixed in place.

### BRIEF DESCRIPTION OF THE DRAWINGS

In the accompanying drawings:

FIG. 1 is an exploded perspective view of an assembled battery according to one of the disclosed embodiments;

FIG. 2 is an external perspective view illustrating the appearance of the assembled battery illustrated in FIG. 1;

FIG. 3 is a functional block diagram schematically illustrating a power supply system including the assembled battery illustrated in FIG. 1;

FIG. 4 is a perspective view illustrating a plurality of battery cells in a state of being housed in a housing, with the housing being omitted;

FIG. 5 is an external perspective view of a lower case illustrated in FIG. 1 as a single body;

FIG. 6 is a top view of the lower case illustrated in FIG. 5;

FIG. 7A is an external perspective view of a cell holder illustrated in FIG. 1 as a single body from the upper side;

FIG. 7B is an external perspective view of the cell holder illustrated in FIG. 1 as a single body from the lower side;

FIG. 8 is an enlarged external perspective view of an inter-cell bus bar attached to the cell holder illustrated in FIG. 1;

FIG. 9 is a view illustrating the adhesion position between the battery cells and the housing in the assembled battery illustrated in FIG. 1;

FIG. 10A is a view schematically illustrating a process of assembling a battery module of the assembled battery illustrated in FIG. 1;

FIG. 10B is a view schematically illustrating the process of assembling the battery module of the assembled battery illustrated in FIG. 1;

FIG. 10C is a view schematically illustrating the process of assembling the battery module of the assembled battery illustrated in FIG. 1;

FIG. 10D is a view schematically illustrating the process of assembling the battery module of the assembled battery illustrated in FIG. 1;

FIG. 10E is a view schematically illustrating the process of assembling the battery module of the assembled battery illustrated in FIG. 1;

FIG. 11 is a schematic view illustrating a modification of a first frame body and a second frame body;

FIG. 12 is an enlarged sectional view illustrating part of the second frame body illustrated in FIG. 11;

FIG. 13 is a schematic view illustrating a modification of the first frame body, the second frame body, and an insulation sheet;

FIG. 14 is a schematic view illustrating a modification of the first frame body and the second frame body;

FIG. 15 is a schematic view illustrating a modification of the first frame body and the second frame body;

FIG. 16 is a schematic view illustrating the cross-sectional shape of the first frame body and the second frame body illustrated in FIG. 15; and

FIG. 17 is a view illustrating a modification of a housing groove illustrated in FIGS. 15 and 16.

### DETAILED DESCRIPTION

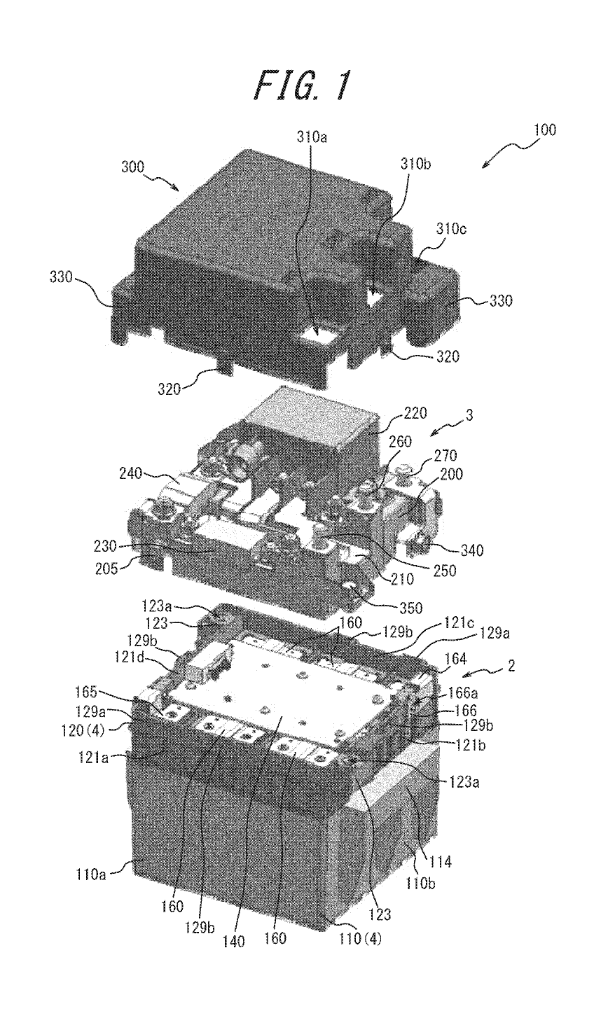

An embodiment of an assembled battery according to the present disclosure will be described below, with reference to FIGS. 1 to 17. In the drawings, common portions or members are given the same reference signs.

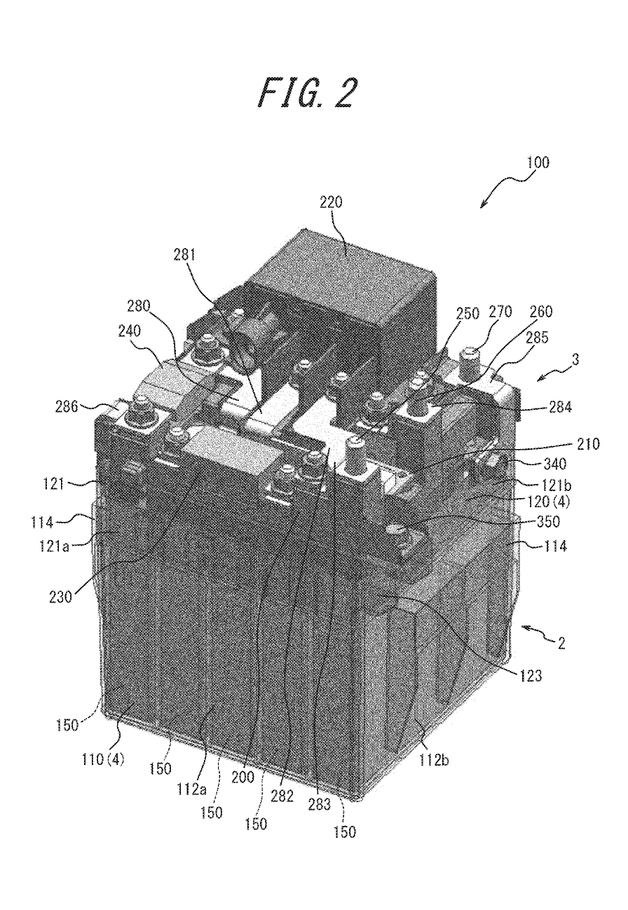

FIG. 1 is an exploded perspective view of an assembled battery 100 according to one of the disclosed embodiments. As illustrated in FIG. 1, the assembled battery 100 includes a battery module 2, an auxiliary module 3, and an upper case 300. The assembled battery 100 is formed by assembling the battery module 2 and the auxiliary module 3 and then fixing them to the upper case 300. FIG. 2 is an external perspective view illustrating the appearance of the assembled battery 100 in an assembled state. In FIG. 2, the upper case 300 is omitted for convenience's sake. Hereafter, the side on which the battery module 2 and the auxiliary module 3 are located with respect to the upper case 300 in FIG. 1 is referred to as the “lower” side and the side on which the auxiliary module 3 and the upper case 300 are located with respect to the battery module 2 in FIG. 1 is referred to as the “upper” side, for convenience's sake.

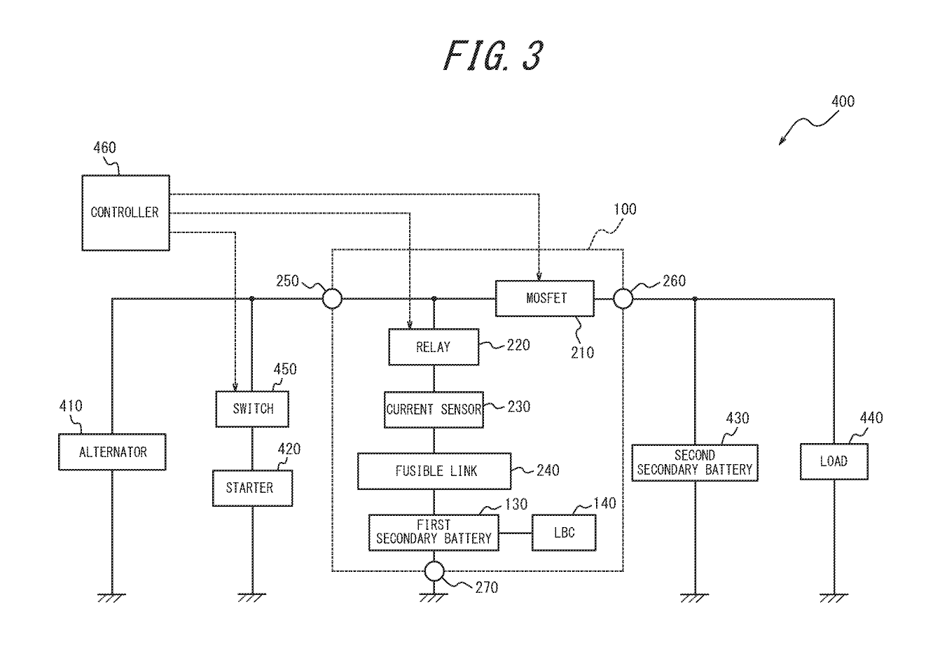

The schematic structure of a power supply system 400 including the assembled battery 100 will be described below. FIG. 3 is a functional block diagram schematically illustrating the power supply system 400 including the assembled battery 100 illustrated in FIGS. 1 and 2. In this embodiment, the assembled battery 100 is described as being mounted and used in a vehicle, such as a vehicle that includes an internal combustion engine or a hybrid vehicle that can run on power of both an internal combustion engine and an electric motor, but the uses of the assembled battery 100 are not limited to vehicles.

As illustrated in FIG. 3, the power supply system 400 includes the assembled battery 100, an alternator 410, a starter 420, a second secondary battery 430, a load 440, a switch 450, and a controller 460. The assembled battery 100 includes a first secondary battery 130 housed in the battery module 2. The first secondary battery 130, the alternator 410, the starter 420, the second secondary battery 430, and the load 440 are connected in parallel.

The assembled battery 100 includes a metal oxide semiconductor field effect transistor (MOSFET) 210, a relay 220, a current sensor 230, a fusible link 240, the first secondary battery 130, and a battery controller (LBC) 140. The relay 220, the current sensor 230, the fusible link 240, and the first secondary battery 130 are connected in series in this order. The MOSFET 210 is connected in series with the second secondary battery 430 and the load 440.

In the assembled battery 100, an SSG terminal 250 is connected to the alternator 410, a LOAD terminal 260 is connected to the load 440, and a GND terminal 270 is used for grounding.

The relay 220 functions as a switch that connects the first secondary battery 130 in parallel with constituent elements outside of the assembled battery 100 in the power supply system 400 or disconnects the first secondary battery 130.

The current sensor 230 has an appropriate structure and uses an appropriate method to measure current flowing in a circuit that includes the first secondary battery 130.

The fusible link 240 is configured by a fuse body, a fuse housing made of insulating resin for holding the fuse body, and a cover made of insulating resin for covering the fuse housing. The fusible link 240 fuses when overcurrent occurs.

The first secondary battery 130 is constituted by an assembly of battery cells 150 housed in the battery module 2, as illustrated in FIG. 2. Each battery cell 150 in the first secondary battery 130 is, for example, a secondary battery such as a lithium-ion battery or a nickel-hydrogen battery. The first secondary battery 130 is connected to the fusible link 240 on the positive electrode side and is grounded through the GND terminal 270 on the negative electrode side. FIG. 2 illustrates the below-described housing 4 of the battery module 2 in a transparent state, for convenience's sake.

The MOSFET 210 functions as a switch that connects the second secondary battery 430 and the load 440 in parallel with other constituent elements in the power supply system 400 or disconnects the second secondary battery 430 and the load 440.

The LBC 140 is connected to the first secondary battery 130, and estimates the state of the first secondary battery 130. For example, the LBC 140 estimates the state of charge (SOC) of the first secondary battery 130.

The alternator 410 is an electrical generator, and is connected mechanically to the vehicle's engine. The alternator 410 generates electricity by being driven by the engine. The output voltage of the electric power that the alternator 410 generates by being driven by the engine is adjusted by a regulator, and the electric power can be supplied to the first secondary battery 130 in the assembled battery 100, the second secondary battery 430, and the load 440. The alternator 410 can also generate electricity by regeneration, for example when the vehicle slows down. The electric power that the alternator 410 generates by regeneration is used to charge the first secondary battery 130 and the second secondary battery 430.

The starter 420 includes a starter motor, for example. The starter 420 receives a power supply from at least one of the first secondary battery 130 and the second secondary battery 430 and starts the engine of the vehicle.

The second secondary battery 430 is, for example, constituted by a lead storage battery. The second secondary battery 430 supplies electric power to the load 440.

The load 440 includes, for example, the audio, air-conditioner, navigation system, and the like provided in the vehicle. The load 440 operates by consuming the supplied electric power. The load 440 operates by receiving the electric power supplied from the first secondary battery 130 while driving of the engine is suspended, and operates by receiving the electric power supplied from the alternator 410 and the second secondary battery 430 during driving of the engine.

The switch 450 is connected in series to the starter 420. The switch 450 connects the starter 420 in parallel with other constituent elements or disconnects the starter 420.

The controller 460 controls overall operations of the power supply system 400. The controller 460 is, for example, constituted by the electronic control unit or engine control unit (ECU) of the vehicle. The controller 460 controls operations of the switch 450, the MOSFET 210, and the relay 220, to supply power with the alternator 410, the first secondary battery 130, and the second secondary battery 430 and charge the first secondary battery 130 and the second secondary battery 430.

In the assembled battery 100 in this embodiment, the MOSFET 210, the relay 220, the current sensor 230, the fusible link 240, the SSG terminal 250, the LOAD terminal 260 and the GND terminal 270 are attached to the auxiliary module 3. In the assembled battery 100 in this embodiment, the three terminals, i.e. the SSG terminal 250, the LOAD terminal 260 and the GND terminal 270, project to the outside of the upper case 300 when the upper case 300 is attached.

The assembled battery 100 in this embodiment will be described in detail below.

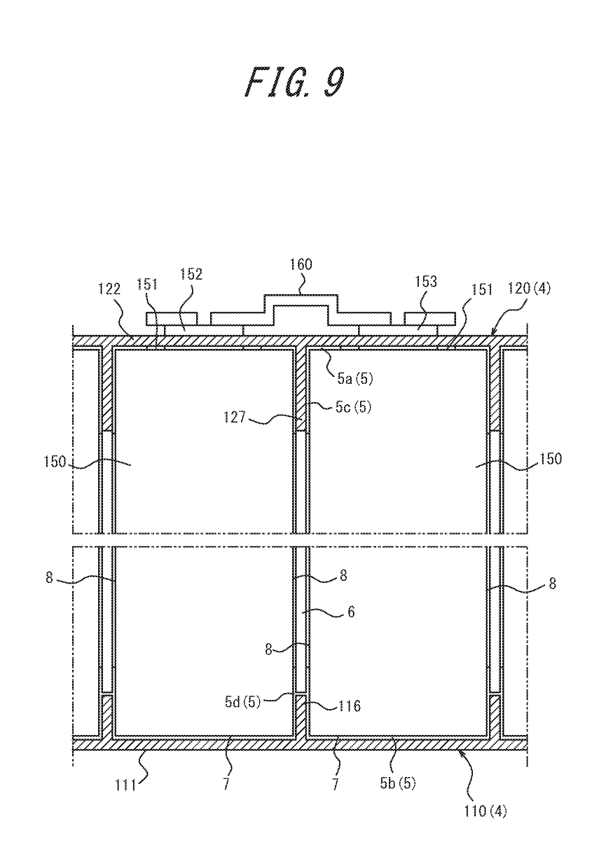

As illustrated in FIGS. 1 and 2, the battery module 2 includes a plurality of battery cells 150, the housing 4 housing the plurality of battery cells 150, an inter-cell bus bar 160 electrically connecting the battery cells 150, a total plus terminal bus bar 165, a total minus terminal bus bar 164, an adhesive portion 5 connecting the battery cells 150 to the housing 4 (FIG. 9), an insulation sheet 6 located between the battery cells 150, and the LBC 140.

The battery cells 150 have a substantially cuboid shape. The assembled battery 100 in this embodiment includes the plurality of battery cells 150. Specifically, the assembled battery 100 in this embodiment houses five battery cells 150. However, the number of battery cells 150 that the assembled battery 100 can house is not limited to five, and may be appropriately determined in accordance with factors such as the maximum output of the battery cells 150 and the electric power consumed by driven devices of the vehicle or the like.

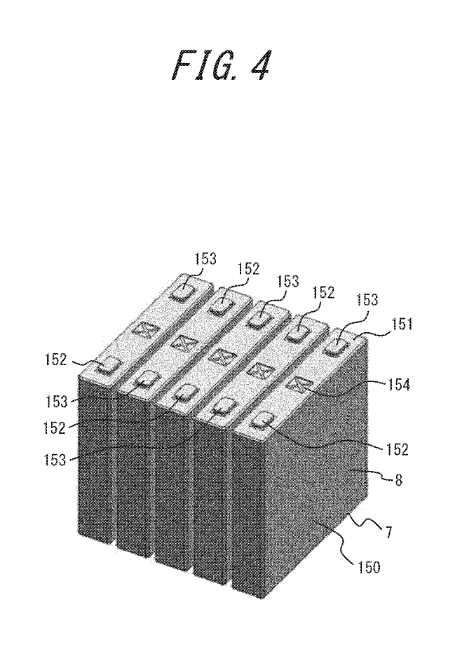

FIG. 4 is a perspective view illustrating the five battery cells 150 in this embodiment in a state of being housed in a housing 4, with the housing 4 being omitted. In other words, the five battery cells 150 in this embodiment are housed in the housing 4 in the state illustrated in FIG. 4. As illustrated in FIG. 4, each battery cell 150 having the substantially cuboid shape includes a positive electrode terminal 152 and a negative electrode terminal 153 on one substantially cuboid cap surface 151. The cap surface 151 is rectangular, with long sides and short sides. The positive electrode terminal 152 and the negative electrode terminal 153 are provided near the edges in the direction of the long sides of the cap surface 151. A safety valve 154 is provided at the center of the cap surface 151. The safety valve 154 opens to discharge gas to the outside when, due to deterioration over time, thermal runaway, or the like, gas is produced inside the battery cell 150 and the inside of the battery cell 150 reaches a predetermined pressure or greater.

As illustrated in FIG. 4, the plurality of battery cells 150 are arranged in the housing 4 so that the positive electrode terminals 152 and the negative electrode terminals 153 of adjacent battery cells 150 alternate.

The surfaces of the battery cell 150 other than the cap surface 151 are even flat surfaces. Specifically, a lower surface 7 of the battery cell 150 opposite to the cap surface 151 and four side surfaces 8 of the battery cell 150 other than the cap surface 151 and the lower surface 7 are even flat surfaces.

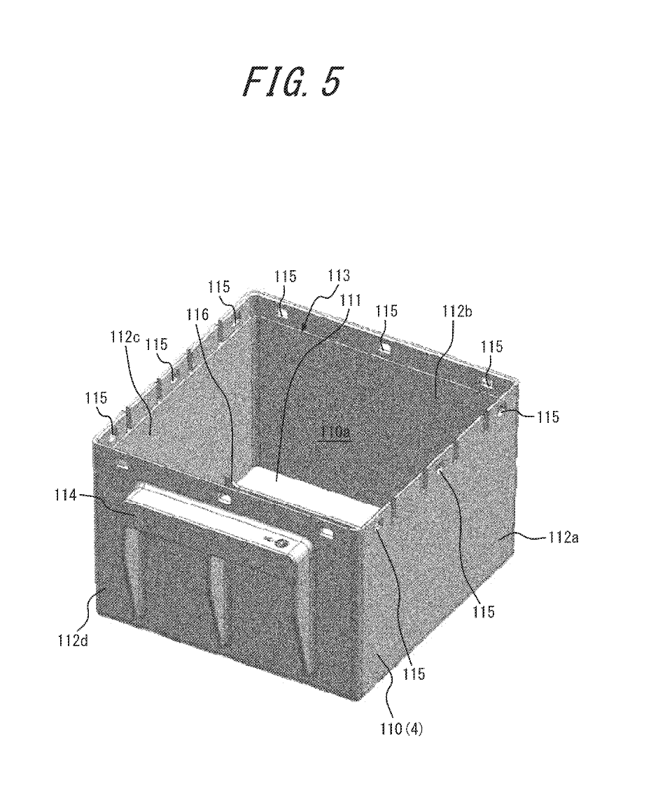

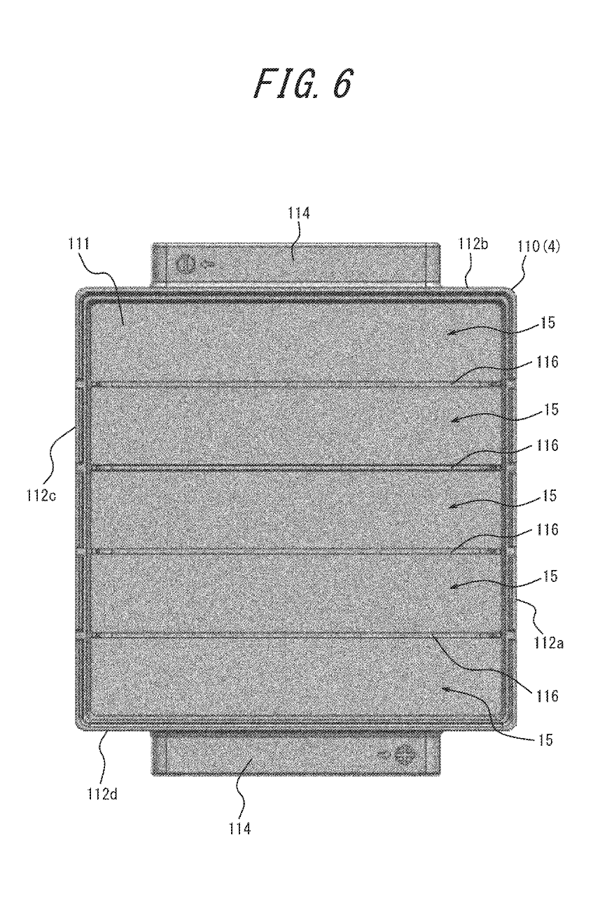

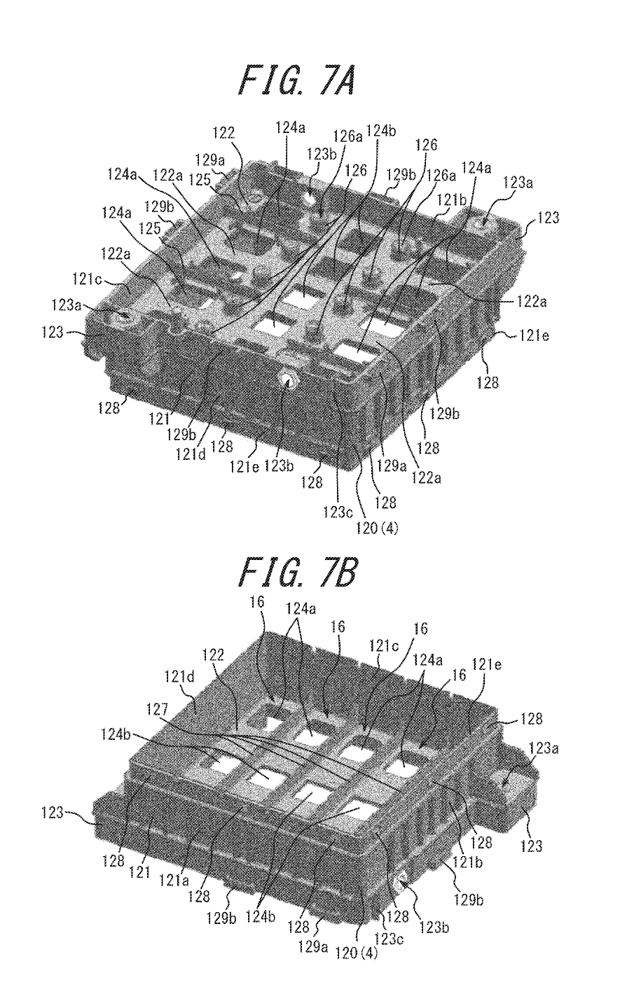

FIG. 5 is an external perspective view of the lower case 110 of the housing 4. FIG. 6 is a top view of the lower case 110 of the housing 4. FIGS. 7A and 7B are each an external perspective view of a cell holder 120 of the housing 4. Specifically, FIG. 7A is an external perspective view of the cell holder 120 from the upper side. FIG. 7B is an external perspective view of the cell holder 120 from the opposite side (hereafter also referred to as “lower side”) from the upper side. The housing 4 has a plurality of first housing spaces 15 for housing one end side of the battery cells 150 and a plurality of second housing spaces 16 for housing the other end side of the battery cells 150, and holds the plurality of battery cells 150 in a state of being housed in the plurality of first housing spaces 15 and the plurality of second housing spaces 16. Specifically, the housing 4 in this embodiment includes the lower case 110 housing the lower side of the battery cell 150 as one end side, and the cell holder 120 housing the upper side of the battery cell 150 as the other side. The plurality of first housing spaces 15 are provided in the lower case 110, and the plurality of second housing spaces 16 are provided in the cell holder 120.

As illustrated in FIG. 5, the lower case 110 is a rectangular box-shaped case that has a space 110a capable of housing the battery cells 150 from the upper side. In other words, the lower case 110 has a bottom wall 111 and four side walls 112a, 112b, 112c, and 112d. The lower case 110 has an opening 113 on the opposite side from the bottom wall 111 (i.e. on the upper side). In the lower case 110, the side walls 112a and 112c face each other, and the side walls 112b and 112d face each other. When not differentiating between the four side walls 112a, 112b, 112c, and 112d, these side walls are collectively referred to below as the side walls 112. The height of the side walls 112 is less than the height of the battery cells 150 housed in the lower case 110. Each battery cell 150 is housed in the lower case 110 so that the cap surface 151 (FIG. 4) projects from the opening 113, i.e. to become the upper side.

The side walls 112b and 112d each include an attachment mechanism 114 for attaching the assembled battery 100 to the vehicle on the outside of the lower case 110 (i.e. on the opposite side from the space 110a). The shape of the attachment mechanism 114 and the position on the side walls 112b and 112d are determined appropriately in accordance with the method of attachment to the vehicle.

The side walls 112 have engaging holes 115 for engagement with the cell holder 120 on the opening 113 side. In this embodiment, each side wall 112 has three engaging holes 115, located at the center and near the edges of the opening 113.

Ribs 116 as a first frame body that project upward and extend in a direction orthogonal to the vertical direction are provided on the upper surface of the bottom wall 111 on the inside of the lower case 110 (i.e. the space 110a side). The ribs 116 as the first frame body indicate the position of the battery cells 150 to be housed, and prevent misalignment of the housed battery cells 150. The ribs 116 are also spacers for maintaining a space between battery cells 150. The below-described insulation sheet 6 is inserted in the space between adjacent battery cells 150 formed by the ribs 116.

The height of the ribs 116 as the first frame body is less than the height of the side walls 112. In this embodiment, four ribs 116 are provided parallel to the side walls 112b and 112d at equal intervals, as illustrated in FIG. 6. In detail, the lower case 110 in this embodiment has five first housing spaces 15 defined by the side walls 112b and 112d and the ribs 116, and the lower end of each battery cell 150 is housed in the corresponding first housing space 15. Accordingly, the five battery cells 150 in this embodiment are disposed to be stacked from the side wall 112b to the side wall 112d. In other words, the five first housing spaces 15 in this embodiment are formed near the bottom wall 111 in the lower case 110.

The position and size of the ribs 116 are appropriately determined in accordance with the shape, number, and the like of the battery cells 150 housed by the lower case 110, and are not limited to the position and size described in this embodiment.

Although the first frame body in this embodiment is constituted by the ribs 116 that project upward from the upper surface of the bottom wall 111 of the lower case 110 and extend in a direction orthogonal to the vertical direction (the direction in which the side walls 112a and 112c face in this embodiment), the first frame body is not limited to the shape of the ribs 116 described this embodiment, and may be any first frame body that defines the plurality of first housing spaces 15 for housing one end side of the battery cells 150. For example, a first frame body extending across the facing side walls 112 without being connected to the bottom wall 111, unlike the ribs 116 projecting from the upper surface of the bottom wall 111 in this embodiment, may be used.

The cell holder 120 is attached at the cap surface 151 side of the battery cell 150, i.e. at the opening 113 side of the lower case 110.

As illustrated in FIGS. 7A and 7B, the cell holder 120 includes an outer frame 121 and a holding lid 122 on the inside of the outer frame 121. The outer frame 121 is substantially rectangular in a top view and has a predetermined height. The holding lid 122 covers and holds the battery cells 150 from the upper side when the cell holder 120 is engaged with the lower case 110.

The outer frame 121 has four side walls 121a, 121b, 121c, and 121d. The four side walls 121a, 121b, 121c, and 121d are disposed at positions corresponding to the four side walls 112a, 112b, 112c, and 112d of the lower case 110 when the outer frame 121 and the lower case 110 are engaged.

The outer frame 121 includes screw hole forming portions 123, at the edges of the side walls 121b and 121d, that each have a screw hole 123a for fixing the auxiliary module 3 to the cell holder 120 by screwing. The screw hole forming portion 123 is formed to project outward from the side walls 121b and 121d. The screw hole 123a is formed in the screw hole forming portion 123 to allow insertion of a screw from the upper side.

The outer frame 121 has screw holes 123b, at the upper side of the side walls 121b and 121d, for screwing bus bars of the auxiliary module 3, i.e. the below-described total plus copper bus bar 286 and total minus copper bus bar 285 (FIG. 2), to the cell holder 120. The screw holes 123b are preferably provided near the opening 124a where the below-described total plus terminal bus bar 165 and total minus terminal bus bar 164 are attached.

The outer frame 121 has an engaging insertion portion 121e with a predetermined height around the entire periphery, as illustrated in FIGS. 7A and 7B. The engaging insertion portion 121e is thinner than other parts of the outer frame 121. Therefore, at the outer surface of the outer frame 121, the engaging insertion portion 121e is recessed more than other parts of the outer frame 121. The engaging insertion portion 121e is inserted into the space 110a in the lower case 110 from the opening 113 of the lower case 110 when the cell holder 120 is engaged with the lower case 110.

On each of the side walls 121a, 121b, 121c, and 121d, the engaging insertion portion 121e includes three engaging claws 128 located at the center and near the edges. The engaging claws 128 are provided at positions corresponding to the engaging holes 115 of the lower case 110. To engage the cell holder 120 with the lower case 110, the engaging claws 128 of the cell holder 120 are fitted into and engaged with the engaging holes 115 of the lower case 110. The cell holder 120 is thus engaged with the lower case 110. The positions and numbers of the engaging holes 115 and the engaging claws 128 are not limited to the example illustrated in this embodiment, and may be determined as appropriate.

The outer frame 121 has engaging holes 129a on the upper side of the side walls 121a and 121c near the screw holes 123b. The engaging holes 129a are provided to project to the outside from the outer frame 121, and are substantially rectangular holes in a top view. The engaging holes 129a are used when the cell holder 120 and the auxiliary module 3 are attached.

The outer frame 121 has an engaging hole 129b at the upper side near the center of each side wall 121a, 121b, 121c, and 121d. The engaging holes 129b are provided to project to the outside from the outer frame 121, and are substantially rectangular holes in a top view. The engaging holes 129b are used when attaching the cell holder 120 and the upper case 300 (FIG. 1). The engaging holes 129b need not be provided near the center of the side walls 121a, 121b, 121c, and 121d, and may be provided at any position that allows engagement with the upper case 300.

The holding lid 122 will be described in detail below. The holding lid 122 holds the battery cells 150 housed in the lower case 110, from the upper side.

The holding lid 122 has openings 124a at positions corresponding to the positive electrode terminals 152 and negative electrode terminals 153 of the battery cells 150 when the cell holder 120 and the lower case 110 are engaged. Hence, the positive electrode terminals 152 and negative electrode terminals 153 of the battery cells 150 are exposed to the upper side of the holding lid 122 through the openings 124a when the cell holder 120 and the lower case 110 are engaged.

The holding lid 122 has openings 124b at positions corresponding to the safety valves 154 of the battery cells 150 when the cell holder 120 and the lower case 110 are engaged. Hence, gas discharged from the safety valves 154 is discharged outside the battery cells 150 through the openings 124b when the cell holder 120 and the lower case 110 are engaged.

Adjacent terminals from among the positive electrode terminals 152 and the negative electrode terminals 153, which are exposed through the openings 124a and arranged in a line, are electrically connected through the inter-cell bus bars 160, except for a positive electrode terminal 152 connected to the fusible link 240 and a negative electrode terminal 153 connected to the GND terminal 270.

The holding lid 122 includes beads 125 between inter-cell bus bars 160 that are attached to the cell holder 120 and between an inter-cell bus bar 160 and the total plus terminal bus bar 165 or the total minus terminal bus bar 164, to prevent electrical connection between the bus bars and to position the bus bars. The beads 125 project toward the upper side of the holding lid 122.

The holding lid 122 also includes screw hole forming portions 126 for fixing the LBC 140 to the upper side, as illustrated in FIGS. 7A and 7B. The screw hole forming portions 126 are formed between the openings 124a and the openings 124b on the upper side of the holding lid 122. In detail, in this embodiment, the holding lid 122 includes ten screw hole forming portions 126. Each screw hole forming portion 126 is substantially cylindrical, and a screw hole 126a is provided at the center thereof. The LBC 140 is mounted on the upper side of the cell holder 120, and is screwed to the cell holder 120 from the upper side using the screw holes 126a formed in the screw hole forming portions 126.

Ribs 127 as a second frame body that project downward and extend in a direction orthogonal to the vertical direction are provided on the lower surface of the holding lid 122 of the cell holder 120 facing the battery cells 150. The rib 127 as the second frame body prevent misalignment of the housed battery cells 150. The ribs 127 are also spacers for maintaining a space between battery cells 150.

The height of the rib 127 as the second frame body from the lower surface of the holding lid 122 is less than the height of the part of the outer frame 121 projecting from the lower surface of the holding lid 122. In this embodiment, four ribs 127 are provided parallel to the side walls 121b and 121d at equal intervals, as illustrated in FIG. 7B. In detail, the cell holder 120 in this embodiment has five second housing spaces 16 defined by the side walls 121b and 121d and the ribs 127, and the upper end of each battery cell 150 is housed in the corresponding second housing space 16. Accordingly, the five battery cells 150 in this embodiment are disposed to be stacked from the side wall 121b to the side wall 121d. In other words, the five second housing spaces 16 in this embodiment are formed near the lower surface of the holding lid 122 of the cell holder 120.

The rib 127 as the second frame body of the cell holder 120 are provided in a direction and at positions corresponding to the ribs 116 as the first frame body of the lower case 110 when the cell holder 120 and the lower case 110 are engaged. More specifically, when the cell holder 120 and the lower case 110 are engaged, the upper end of each battery cell 150 is housed in the second housing space 16, and the lower end of each battery cell 150 is housed in the first housing space 15, and the ribs 116 as the first frame body and the rib 127 as the second frame body face each other in the vertical direction at positions between adjacent battery cells 150. Therefore, the space between adjacent battery cells 150 formed by the ribs 116 described above is the same as the space between adjacent battery cells 150 formed by the ribs 127. The below-described insulation sheet 6 is placed in this space.

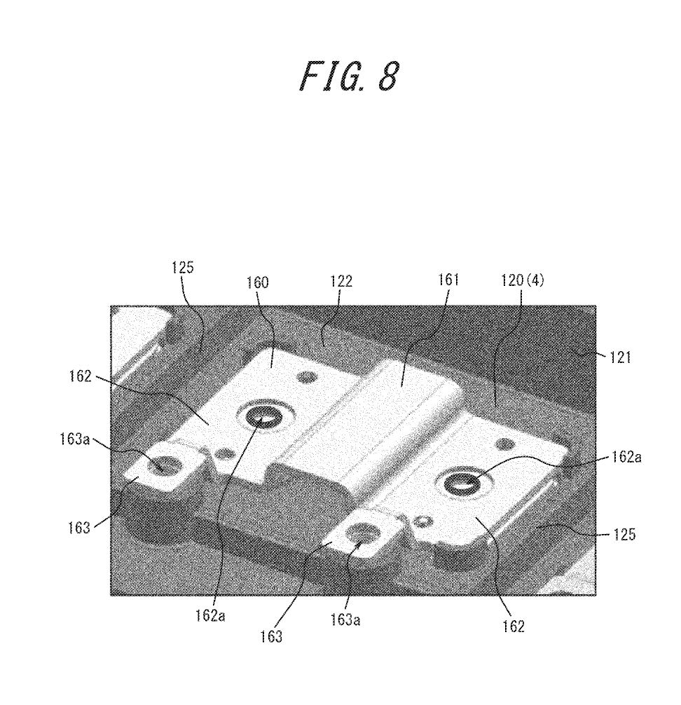

The bus bars that electrically connect the plurality of battery cells 150 held by the lower case 110 and the cell holder 120 will be described below. FIG. 8 is an enlarged external perspective view of the inter-cell bus bar 160 attached to the cell holder 120. The inter-cell bus bar 160 is, for example, made of a conductive metal such as aluminum. The inter-cell bus bar 160 has a convex portion 161 for avoiding interference with a frame portion 122a (FIG. 4) of the holding lid 122 between openings 124a (FIGS. 7A and 7B) when the inter-cell bus bar 160 is attached to the cell holder 120 and connected to the positive electrode terminal 152 and the negative electrode terminal 153 (FIG. 4) of the battery cell 150. In other words, in a side view, the inter-cell bus bar 160 has two terminal connectors 162 connecting to the positive electrode terminal 152 and the negative electrode terminal 153 and the convex portion 161 connecting the two terminal connectors 162 and projecting from the terminal connectors 162 toward the upper side.

The terminal connectors 162 have openings for welding 162a at the center, for example as illustrated in FIG. 8. The inter-cell bus bars 160 and the below-described total plus terminal bus bar 165 and total minus terminal bus bar 164 are connected to the terminals of the battery cells 150 by bead welding at the periphery of the openings for welding 162a.

Each terminal connector 162 has a voltage sensor attachment terminal 163 that projects toward the opening 124b (FIGS. 7A and 7B) when the terminal connector 162 is attached to the cell holder 120. Each voltage sensor attachment terminal 163 has a screw hole 163a. In the inter-cell bus bar 160, each voltage sensor attachment terminal 163 is formed to be disposed on the screw hole forming portion 126 (FIGS. 7A and 7B) when the terminal connector 162 of the inter-cell bus bar 160 is connected to the positive electrode terminal 152 or the negative electrode terminal 153 (FIG. 4). The screw hole 163a overlaps with the screw hole 126a (FIGS. 7A and 7B) formed in the screw hole forming portion 126 when the voltage sensor attachment terminal 163 is disposed on the screw hole forming portion 126. By screwing of the LBC 140 (FIGS. 7A and 7B), the screw hole 126a and the screw hole 163a are screwed together. The voltage sensor attachment terminal 163 is connected to a voltage sensor, and used to detect the voltage between terminals.

The total plus terminal bus bar 165 (FIG. 1) is connected to the positive electrode terminal 152 (FIG. 4) connected to the fusible link 240 (FIGS. 1 and 2).

The total minus terminal bus bar 164 (FIG. 1) is connected to the negative electrode terminal 153 (FIG. 4) connected to the GND terminal 270 (FIGS. 1 and 2).

The total plus terminal bus bar 165 and the total minus terminal bus bar 164 are, for example, made of a conductive metal such as aluminum. The total plus terminal bus bar 165 and the total minus terminal bus bar 164 each have one terminal connector 162 (FIG. 8, the bus bar illustrated in FIG. 8 is the inter-cell bus bar 160 and accordingly two terminal connectors 162 are illustrated) connected to the positive electrode terminal 152 or the negative electrode terminal 153 of the battery cell 150, and an external connector 166 (FIG. 1) for connecting to the total plus copper bus bar 286 or the total minus copper bus bar 285 (FIG. 2) attached to the auxiliary pedestal 200 of the auxiliary module 3. The external connector 166 and the terminal connector 162 in this embodiment are integrally formed through a connecting portion U-shaped in cross section that projects more upward than the terminal connector 162 and clamps the outer frame 121 (FIGS. 7A and 7B) of the cell holder 120 from the top end. Hence, the external connector 166 is located outside the outer frame 121. In particular, as illustrated in FIGS. 7A and 7B, the external connector 166 is attached along a bus bar support 123c formed to extend from the inner surface to the outer surface of the outer frame 121. The external connector 166 (FIG. 1) has insertion holes 166a (FIG. 1) at positions corresponding to the screw holes 123b (FIGS. 7A and 7B) when the external connector 166 (FIG. 1) is attached to the outer frame 121 (FIGS. 7A and 7B). The terminal connector 162 of the total plus terminal bus bar 165 and the total minus terminal bus bar 164 also has a voltage sensor attachment terminal 163 (FIG. 8) that projects toward the opening 124b (FIGS. 7A and 7B) when the terminal connector 162 is attached to the cell holder 120.

The adhesive portion 5 is in contact with each battery cell 150 and the housing 4, and adheres the battery cell 150 to the housing 4. The adhesive portion 5 in this embodiment is constituted by an adhesive interposed between each battery cell 150 and the housing 4. The adhesive as the adhesive portion 5 may be any adhesive that can adhere the battery cells 150 to the housing 4, such as an epoxy adhesive.

FIG. 9 is a view illustrating the adhesion positions between the battery cells 150 and the housing 4. FIG. 9 illustrates a longitudinal section at the center position in the longitudinal direction of the cap surface 151 of the battery cell 150. As illustrated in FIG. 9, each battery cell 150 in this embodiment is adhered to the lower case 110 and the cell holder 120 by the adhesive portions 5, in a state in which its lower portion is housed in the first housing space 15 formed in the lower case 110 of the housing 4 and its upper portion is housed in the second housing space 16 formed in the cell holder 120 of the housing 4. Specifically, each battery cell 150 in this embodiment is adhered to the lower case 110 by the adhesive portions 5 interposed between the battery cell 150 and the lower case 110, and adhered to the cell holder 120 by the adhesive portions 5 interposed between the battery cell 150 and the cell holder 120.

The adhesive as the adhesive portion 5 need not necessarily be in contact with the whole battery cell 150. The adhesive as the adhesive portion 5 in this embodiment is in contact with the cap surface 151 of each battery cell 150, the lower surface 7 of the battery cell 150 opposite to the cap surface 151, and the lower end and the upper end of the side surfaces 8 of the battery cell 150.

More specifically, in this embodiment, an adhesive portion (hereafter referred to as “first adhesive portion 5a”) in contact with the cap surface 151 of the battery cell 150 from among the adhesive portions 5 is in contact with only the periphery of the cap surface 151 so as not to be in contact with the positive electrode terminal 152, the negative electrode terminal 153, and the safety valve 154 and is interposed between the cap surface 151 and the lower surface of the holding lid 122 of the cell holder 120, thus adhering the cap surface 151 to the lower surface of the holding lid 122 .

An adhesive portion (hereafter referred to as “second adhesive portion 5b”) in contact with the lower surface 7 of the battery cell 150 from among the adhesive portions 5 is in contact with at least part of the lower surface 7 and is interposed between the lower surface 7 and the upper surface of the bottom wall 111 of the lower case 110, thus adhering the lower surface 7 to the upper surface of the bottom wall 111.

An adhesive portion (hereafter referred to as “third adhesive portion Sc”) in contact with the upper end of the side surface 8 of the battery cell 150 from among the adhesive portions 5 is interposed between the upper end of the side surface 8 and the side surface of the rib 127 as the second frame body of the cell holder 120, thus adhering the upper end of the side surface 8 to the side surface of the rib 127.

An adhesive portion (hereafter referred to as “fourth adhesive portion 5d”) in contact with the lower end of the side surface 8 of the battery cell 150 from among the adhesive portions 5 is interposed between the lower end of the side surface 8 and the side surface of the ribs 116 as the first frame body of the lower case 110, thus adhering the lower end of the side surface 8 to the side surface of the rib 116.

In other words, of the adhesive portions 5, the first adhesive portion 5a and the third adhesive portion 5c are holder adhesive portions adhering the battery cell 150 to the cell holder 120, and the second adhesive portion 5b and the fourth adhesive portion 5d are case adhesive portions adhering the battery cell 150 to the lower case 110.

The position of the adhesive as the adhesive portion 5 may be any position where each battery cell 150 can be adhesively fixed to the housing 4 and the below-described insulation sheet 6 can be adhesively fixed, and is not limited to the position illustrated in FIG. 9 in this embodiment.

Although the first adhesive portion 5a and the third adhesive portion 5c as the holder adhesive portions in this embodiment are connected and form a single adhesion region, the first adhesive portion 5a and the third adhesive portion 5c may be separate from each other. Although the second adhesive portion 5b and the fourth adhesive portion 5d as the case adhesive portions in this embodiment are connected and form a single adhesion region, the second adhesive portion 5b and the fourth adhesive portion 5d may be separate from each other.

Although the adhesive as the second adhesive portion 5b is applied between the battery cell 150 and the bottom surface of the lower case 110 (in this embodiment, the upper surface of the bottom wall 111) in this embodiment, another filler may be interposed instead of the adhesive. The filler preferably has elasticity. By applying the filler with elasticity between the battery cells 150 and the bottom surface of the lower case 110, vibration occurring during running of the vehicle provided with the assembled battery 100 is absorbed by the filler. Therefore, vibration is not easily transmitted to the battery cells 150.

The insulation sheet 6 is located between the plurality of battery cells 150, as illustrated in FIG. 9. In this embodiment, the insulation sheet 6 is located in each of the four gaps formed between the five battery cells 150. The insulation sheet 6 can prevent a short circuit between the battery cells 150. The insulation sheet 6 may be made of, for example, a resin material such as polyethylene or polypropylene.

The insulation sheet 6 is interposed between the rib 116 as the first frame body and the rib 127 as the second frame body, and also in contact with the adhesive portion 5. Thus, the insulation sheet 6 is fixed in place by the adhesive as the adhesive portion 5, between the ribs 116 and 127. In this way, the insulation sheet 6 is prevented from moving between the battery cells 150 due to, for example, vibration during running of the vehicle on which the assembled battery 100 is mounted, so that abnormal noise can be suppressed.

More specifically, the third adhesive portion 5c in this embodiment spreads more downward than the lower end of the rib 127 as the second frame body, and the upper end of the insulation sheet 6 is in contact with the third adhesive portion 5c at a position lower than the lower end of the rib 127. The fourth adhesive portion 5d in this embodiment spreads more upward than the upper end of the rib 116 as the first frame body, and the lower end of the insulation sheet 6 is in contact with the fourth adhesive portion 5d at a position higher than the upper end of the rib 116.

Although the insulation sheet 6 in this embodiment is fixed in place in a state of being in contact with the third adhesive portion 5c as the holder adhesive portion and the fourth adhesive portion 5d as the case adhesive portion, the present disclosure is not limited to this structure. For example, the insulation sheet 6 may be fixed in place in contact with only one of the holder adhesive portion and the case adhesive portion.

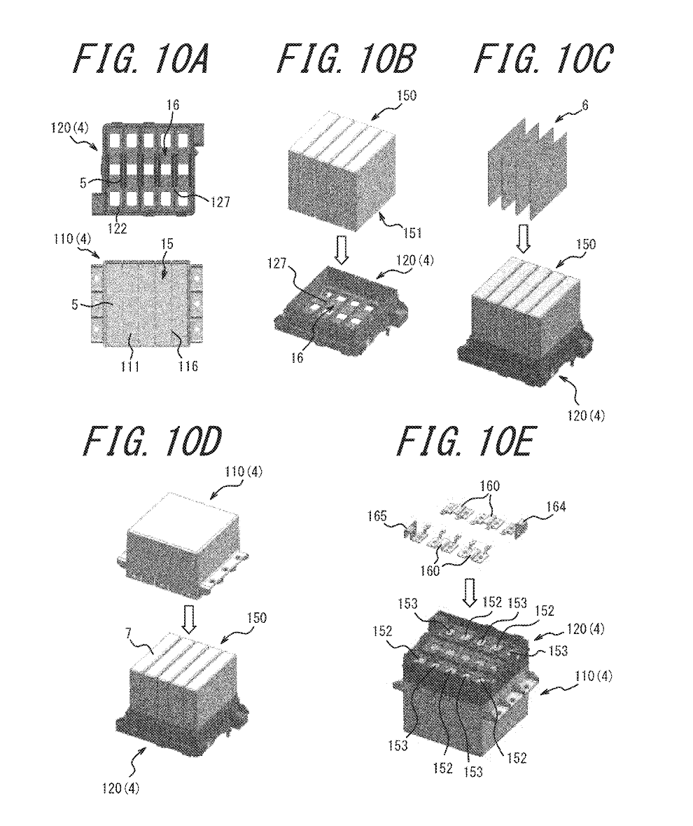

Assembly of the battery module 2 will be described below. FIGS. 10A to 10E are schematic views illustrating steps of assembling the battery module 2 in sequence.

FIG. 10A illustrates a step of applying the adhesive (indicated by reference sign 5 in FIG. 10A) as the adhesive portion 5 to the lower case 110 and the cell holder 120. The adhesive is applied to predetermined positions of the lower case 110 and the cell holder 120 so that the first adhesive portion 5a to the fourth adhesive portion 5d (FIG. 9) are formed when the battery cells 150 are housed in the first housing space 15 and the second housing space 16. In this embodiment, the adhesive is applied to substantially the entire region that is the center region of the upper surface of the bottom wall 111 of the lower case 110 in the extension direction of the ribs 116 and in which the ribs 116 are not formed. With this adhesive, the second adhesive portion 5b and the fourth adhesive portion 5d (FIG. 9) are formed. Moreover, the adhesive is applied to substantially the entire region that is the center region of the lower surface of the holding lid 122 of the cell holder 120 in the extension direction of the ribs 127 and extends across the side surface of the base end of the ribs 127 and the lower surface of the holding lid 122. With this adhesive, the first adhesive portion 5a and the third adhesive portion 5c (FIG. 9) are formed.

The positions to which the adhesive is applied are not limited to the positions illustrated in FIG. 10A. For example, the adhesive may be applied to both end regions in the extension direction of the ribs 116 and 127. The adhesive applied to the lower case 110 and the cell holder 120 may be applied to both of the center region and the end region in the extension direction of the ribs 116 and 127. Here, the adhesive needs to be kept from being in contact with the positive electrode terminal 152, the negative electrode terminal 153, and the safety valve 154 on the cap surface 151 (FIG. 4). The adhesive application position in the extension direction of the ribs 116 and 127 may differ between the lower case 110 and the cell holder 120. Although the adhesive is applied to the lower case 110 and the cell holder 120 in this embodiment, the adhesive may be applied to the battery cells 150.

FIG. 10B illustrates a step of setting the battery cells 150 in the cell holder 120. With the cell holder 120 turned upside down and the cap surface 151 of each battery cell 150 facing downward, the battery cells 150 are inserted in accordance with the ribs 127 at the lower side of the holding lid 122 of the cell holder 120 (the upper side in the state in FIG. 10B) (see the outline arrow in FIG. 10B). As a result, the end of each battery cell 150 on the cap surface 151 side is housed in the second housing space 16 defined by the ribs 127. The first adhesive portion 5a and the third adhesive portion 5c (FIG. 9) adhering the battery cells 150 and the cell holder 120 are thus formed.

Here, the adhesive as the third adhesive portion 5c applied in the step illustrated in FIG. 10A sticks out and spreads to a lower position (an upper position in the state in FIG. 10B) than the lower end of the rib 127 (the upper end in the state in FIG. 10B) when each battery cell 150 is fitted into the second housing space 16 of the cell holder 120.

FIG. 10C illustrates a step of inserting the insulation sheets 6 between the battery cells 150. Each insulation sheet 6 is inserted between the battery cells 150 until its front end in the insertion direction comes into contact with the adhesive spreading to a lower position than the lower end of the rib 127 (see the outline arrow in FIG. 10C). Preferably, each insulation sheet 6 is inserted until its front end in the insertion direction comes into contact with the adhesive and abuts the lower end of the rib 127.

FIG. 10D illustrates a step of setting the lower case 110 on the cell holder 120. With the lower case 110 turned upside down, the lower case 110 is engaged with the cell holder 120 so as to cover the cell holder 120 in which the battery cells 150 are inserted (see the outline arrow in FIG. 10D). Here, the engaging claws 128 (FIG. 7) of the cell holder 120 are engaged with the engaging holes 115 (FIG. 5) of the lower case 110.

In this embodiment, when the lower case 110 is engaged with the cell holder 120, the end of each battery cell 150 on the lower surface 7 side is housed in the first housing space 15 (FIG. 6, etc.) defined by the ribs 116 (FIG. 6). The second adhesive portion 5b and the fourth adhesive portion 5d (FIG. 9) adhering the battery cells 150 and the lower case 110 are thus formed. The adhesive as the fourth adhesive portion 5d applied in the step illustrated in FIG. 10A sticks out and spreads to an upper position (a lower position in the state in FIG. 10D) than the upper end of the rib 116 (the lower end in the state in FIG. 10D) when each battery cell 150 is fitted into the first housing space 15 of the lower case 110. Therefore, in this embodiment, when the lower case 110 is engaged with the cell holder 120, the adhesive stuck out to an upper position than the upper end of the rib 116 comes into contact with the insulation sheet 6. The insulation sheet 6 in this embodiment is thus fixed in place by not only the third adhesive portion 5c but also the fourth adhesive portion 5d.

When each battery cell 150 is housed in the first housing space 15 of the lower case 110 and the second housing space 16 of the cell holder 120, the distance between the battery cell 150 and the rib 127 is shorter than the distance between the battery cell 150 and the rib 116. The shorter distance between the battery cell 150 and the rib 127 is intended to enhance the positioning accuracy of the positive electrode terminal 152, the negative electrode terminal 153, etc. on the cap surface 151 with respect to the cell holder 120. The positioning accuracy of the lower surface 7 with respect to the lower case 110 need not be as high as the positioning accuracy of the cap surface 151 with respect to the cell holder 120. Hence, the distance between the battery cell 150 and the rib 116 is relatively long so that assembling tolerance can be absorbed. As illustrated in FIG. 10B, when the battery cell 150 is inserted into the second housing space 16 of the cell holder 120 to form the third adhesive portion 5c (FIG. 9), the adhesive sticks out and spreads to a lower position (an upper position in the state in FIG. 10B) than the lower end of the rib 127 (the upper end in the state in FIG. 10B) through the space between the battery cell 150 and the rib 127, depending on application quantity, capillarity, and viscosity. Likewise, as illustrated in FIG. 10D, when the battery cell 150 is inserted into the first housing space 15 of the lower case 110 to form the fourth adhesive portion 5d (FIG. 9), the adhesive sticks out and spreads to an upper position (a lower position in the state in FIG. 10D) than the upper end of the rib 116 (the lower end in the state in FIG. 10D) through the space between the battery cell 150 and the rib 116, depending on application quantity, gravity, and viscosity. Thus, as illustrated in FIG. 9, the third adhesive portion 5c can be spread to a lower position than the lower end of the rib 127, and the fourth adhesive portion 5d can be spread to an upper position than the upper end of the rib 116. Since a step of applying the adhesive only to adhere the insulation sheet 6 to one of the battery cell 150, the lower case 110, and the cell holder 120 can be omitted, the manufacturing cost can be reduced.

FIG. 10E illustrates a step of attaching the inter-cell bus bars 160, the total plus terminal bus bar 165, and the total minus terminal bus bar 164. After the step in FIG. 10D, the assembled battery cells 150, lower case 110, cell holder 120, and insulation sheets 6 are turned upside down, and the inter-cell bus bars 160, the total plus terminal bus bar 165, and the total minus terminal bus bar 164 are attached by welding to the positive electrode terminals 152 and the negative electrode terminals 153 exposed from the openings 124a of the cell holder 120 (see the outline arrow in FIG. 10E).

Following this, the LBC 140 (FIG. 1) is attached to the holding lid 122. This completes the assembly of the battery module 2. The LBC 140 is attached to the holding lid 122 by screwing, for example.

Although the battery module 2 in this embodiment is assembled through these steps, the assembly is not limited to these steps. For example, without turning the lower case 110 and the cell holder 120 upside down, the battery cells 150 may be inserted in the space 110a (FIG. 5) of the lower case 110, and the cell holder 120 may be engaged with the lower case 110 from above.

The auxiliary module 3 of the assembled battery 100 in this embodiment will be described below. As illustrated in FIG. 2, the auxiliary module 3 includes the auxiliary pedestal 200, the MOSFET 210, the relay 220, the current sensor 230, and the fusible link 240 placed on the auxiliary pedestal 200, and copper bus bars for electrically connecting the components on the auxiliary pedestal 200.

As illustrated in FIG. 2, the copper bus bars in this embodiment include a copper bus bar 280 electrically connecting a terminal of the fusible link 240 and one terminal of the current sensor 230, a copper bus bar 281 electrically connecting the other terminal of the current sensor 230 and one terminal of the relay 220, a copper bus bar 282 electrically connecting the other terminal of the relay 220 and a terminal of the MOSFET 210, a copper bus bar 283 electrically connected to the copper bus bar 282 and electrically connecting the other terminal of the relay 220 and the SSG terminal 250 through the copper bus bar 282, a copper bus bar 284 electrically connecting a terminal of the MOSFET 210 and the LOAD terminal 260, the total plus copper bus bar 286 electrically connecting a terminal of the fusible link 240 and the total plus terminal bus bar 165 of the battery module 2, and the total minus copper bus bar 285 electrically connecting the GND terminal 270 and the total minus terminal bus bar 164 of the battery module 2.

The upper case 300 will be described below. As illustrated in FIG. 1, the upper case 300 has three openings 310a, 310b, and 310c for exposing the SSG terminal 250, the LOAD terminal 260, and the GND terminal 270 to the outside from the upper case 300 when the assembled battery 100 is assembled.

The upper case 300 also includes engaging claws 320 for engaging with the cell holder 120 at the lower side of the four side surfaces. The engaging claws 320 are provided at positions corresponding to the engaging holes 129b when the cell holder 120 and the upper case 300 are attached together. The engaging claws 320 extend toward the bottom from the outer side of each side surface. The tips of the engaging claws 320 are wedge-shaped in a side view. The engaging claws 320 engage with the engaging holes 129b by the tips of the engaging claws 320 being fitted into the engaging holes 129b.

The upper case 300 includes bus bar protectors 330 for protecting the total plus copper bus bar 286 and the total minus copper bus bar 285 when the cell holder 120 and the upper case 300 are attached together.

Assembly of the entire assembled battery 100 will be described below. First, attachment of the battery module 2 and the auxiliary module 3 will be described. The battery module 2 and the auxiliary module 3 are attached together by attaching the cell holder 120 to the auxiliary pedestal 200. The cell holder 120 and the auxiliary pedestal 200 are attached together by the engaging claws 205 being fitted into and engaged with the engagement holes 129a (FIG. 1). The cell holder 120 and the auxiliary pedestal 200 are attached together using bolts 340, with the auxiliary pedestal 200 being placed on the cell holder 120. Specifically, the bolts 340 are screwed in a state in which the insertion holes formed in the total plus copper bus bar 286 and the total minus copper bus bar 285 fixed to the auxiliary pedestal 200, the insertion holes 166a formed in the external connectors 166 of the total plus terminal bus bar 165 and the total minus terminal bus bar 164, and the screw holes 123b of the cell holder 120 communicate with each other. Thus, the cell holder 120 and the auxiliary pedestal 200 can be attached together indirectly through the total plus copper bus bar 286 and the total minus copper bus bar 285.

Furthermore, as illustrated in FIG. 1, the cell holder 120 and the auxiliary pedestal 200 are attached together by screwing, by the cell holder 120 being placed on the auxiliary pedestal 200 and bolts 350 then being screwed from the upper side into the screw holes 123a of the cell holder 120.

The upper case 300 is then attached. The upper case 300 is engaged with the cell holder 120 by the engaging claws 320 being fitted into and engaged with the engagement holes 129b of the cell holder 120. By the upper case 300 thus being engaged with the cell holder 120, assembly of the entire assembled battery 100 is complete.

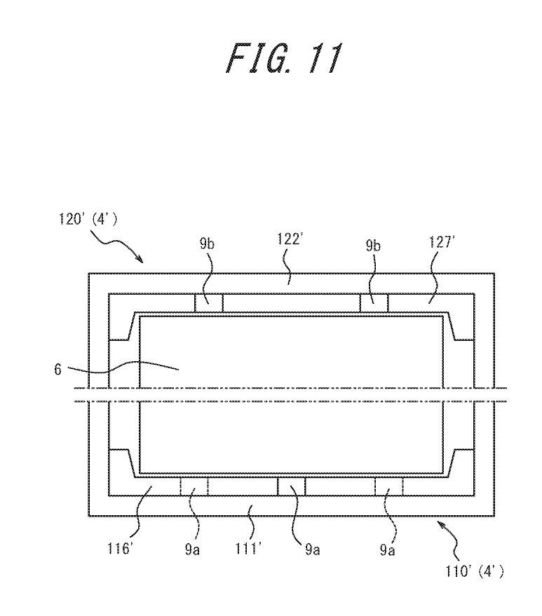

A modification of the ribs 116 as the first frame body, the ribs 127 as the second frame body, and the insulation sheets 6 in this embodiment will be described below, with reference to FIGS. 11 to 17.

FIG. 11 is a schematic view illustrating a modification of the first frame body and the second frame body in this embodiment. A housing 4′ illustrated in FIG. 11 includes a lower case 110′ and a cell holder 120′.

The rib 116′ as the first frame body illustrated in FIG. 11 differs from the rib 116 in the foregoing embodiment in that it has an adhesion facilitating portion that facilitates the contact of the adhesive portion 5 with the insulation sheet 6, but is the same as the rib 116 in the other structures. The rib 127′ as the second frame body illustrated in FIG. 11 differs from the rib 127 in the foregoing embodiment in that it has an adhesion facilitating portion that facilitates the contact of the adhesive portion 5 with the insulation sheet 6, but is the same as the rib 127 in the other structures.

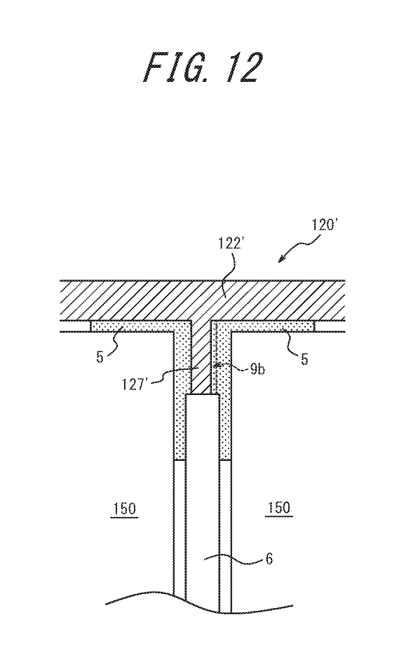

FIG. 12 is an enlarged sectional view illustrating part of the rib 127′ illustrated in FIG. 11. As illustrated in FIGS. 11 and 12, the adhesion facilitating portion of the rib 127′ as the second frame body is a groove 9b formed in the rib 127′ as the second frame body. More specifically, the groove 9b extending in the vertical direction is formed at the side surface of the rib 127′. The upper end of the groove 9b is closed by the lower surface of a holding lid 122′ of the cell holder 120′. The lower end of the groove 9b extends to the lower end of the rib 127′ and is open.

With the rib 127′ as the second frame body illustrated in FIGS. 11 and 12, the adhesive as the third adhesive portion 5c (FIG. 9) easily reaches to a lower position than the lower end of the rib 127′ through the groove 9b as the adhesion facilitating portion, as compared with the rib 127 without the groove 9b as the adhesion facilitating portion. A structure that facilitates contact between the insulation sheet 6 and the third adhesive portion 5c can thus be realized. A plurality of (two in the example in FIG. 11) grooves 9b are arranged with a predetermined interval, in the extension direction of the rib 127′. Adjacent grooves 9b in the extension direction of the rib 127′ may be formed at the same side surface or different side surfaces of the rib 127′. In the example in FIG. 11, adjacent grooves 9b are formed on the same side surface of the rib 127′. In FIG. 11, grooves (two grooves 9a on both sides in FIG. 11) formed at the side surface on the further side in the direction perpendicular to the drawing are indicated by dashed lines.

The thickness of the rib 127′ at the position of the groove 9b is preferably less than the thickness of the insulation sheet 6. With such a structure, the adhesive as the third adhesive portion 5c moving through the groove 9b can easily come into contact with not only the surface of the insulation sheet 6 in the thickness direction but also the upper end surface of the insulation sheet 6 at the open position of the lower end of the groove 9b. As a result of the adhesive being in contact with the upper end surface, too, the area of the insulation sheet 6 in contact with the adhesive increases, so that the insulation sheet 6 can be adhesively fixed more firmly.

While FIG. 12 illustrates the groove 9b of the rib 127′ as the second frame body, the groove 9a (FIG. 11) of the rib 116′ as the first frame body formed at the bottom wall 111′ of the lower case 110′ is the same as the groove 9b except that the upper and lower sides are inverted. Accordingly, the adhesive as the fourth adhesive portion 5d (FIG. 9) easily reaches an upper position than the upper end of the rib 116′ through the groove 9a. The thickness of the rib 116′ at the position of the groove 9a is preferably less than the thickness of the insulation sheet 6, for the same reason as the groove 9b.

The grooves 9a and 9b as the adhesion facilitating portion illustrated in FIGS. 11 and 12 are formed at different positions in the extension direction of the ribs 116′ and 127′. Excessive variation of adhesivity in the extension direction of the ribs 116′ and 127′ can thus be suppressed. This prevents partial peeling of the insulation sheet 6 in a part in the extension direction of the ribs 116′ and 127′.

Although both of the grooves 9a and 9b are formed in FIG. 11, either one of the grooves 9a and 9b may be formed. To facilitate adhesive fixing of the insulation sheet 6, the grooves 9a and 9b are preferably both formed.

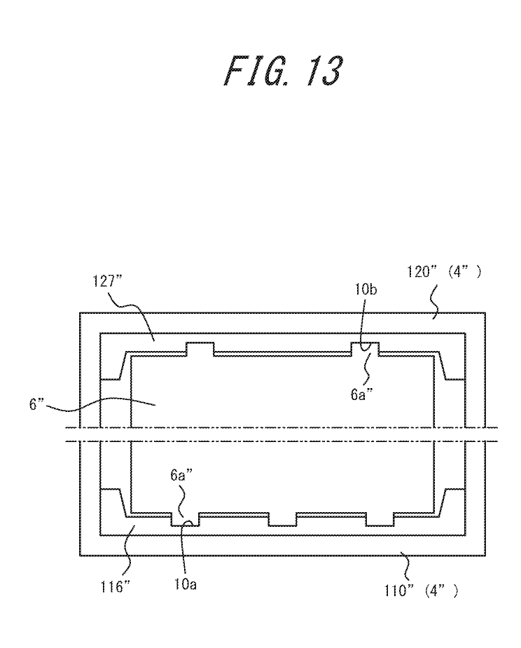

FIG. 13 is a schematic view illustrating another modification of the first frame body, the second frame body, and the insulation sheet in this embodiment. A housing 4″ illustrated in FIG. 13 includes a lower case 110″ and a cell holder 120″.

In the example illustrated in FIG. 1, the adhesion facilitating portion is composed of a projection 6a″ provided on the insulation sheet 6″, a groove 10a formed at the top end surface of a rib 116″ as the first frame body of the lower case 110″, and a groove 10b formed at the top end surface of a rib 127″ as the second frame body of the cell holder 120″.

The insulation sheet 6″ differs from the insulation sheet 6 in the foregoing embodiment in that it has the projections 6a″ at the upper end and the lower end, but is the same as the insulation sheet 6 in the other structures. The rib 116″ differs from the rib 116 in the foregoing embodiment in that it has, at the top end surface, a groove 10a that passes through the rib 116″ in the thickness direction and into which the projection 6a″ at the lower end of the insulation sheet 6″ is fitted, but is the same as the rib 116 in the other structures. The rib 127″ differs from the rib 127 in the foregoing embodiment in that it has, at the top end surface, a groove 10b that passes through the rib 127″ in the thickness direction and into which the projection 6a″ at the upper end of the insulation sheet 6″ is fitted, but is the same as the rib 127 in the other structures.

With the projections 6a″ at the upper and lower ends of the insulation sheet 6″, the groove 10a of the rib 116″, and the groove 10b of the rib 127″, the third adhesive portion 5c and the fourth adhesive portion 5d (FIG. 9) as the holder adhesive portion can easily come into contact with the insulation sheet 6″, and the insulation sheet 6″ can be adhesively fixed more easily.

In the example illustrated in FIG. 13, the projections 6a″ are provided at both of the upper and lower ends of the insulation sheet 6″, and the grooves 10a and 10b are provided on both of the ribs 116″ and 127″. Alternatively, the projections 6a″ may be provided at either one of the upper and lower ends of the insulation sheet 6″, and grooves may be formed in the rib 116″ or 127″ corresponding to the upper or lower end of the insulation sheet 6″ provided with the projections 6a″.

As illustrated in FIG. 13, a plurality of projections 6a″ are formed at each of the upper and lower ends of the insulation sheet 6″. The positions of the projections 6a″ at the upper end of the insulation sheet 6″ are preferably different from positions corresponding to the positive electrode terminal 152, the negative electrode terminal 153, and the safety valve 154 (FIG. 4) of the battery cell 150. Since no groove 10b is formed in the rib 127″ near the positive electrode terminal 152, the negative electrode terminal 153, and the safety valve 154, a wide adhesion area of the battery cell 150 and the rib 127″ can be secured, as compared with a structure in which the groove 10b is formed at such positions. This ensures the bond strength between the battery cell 150 and the cell holder 120″ near the positive electrode terminal 152 and the negative electrode terminal 153, and also ensures sealing near the safety valve 154.

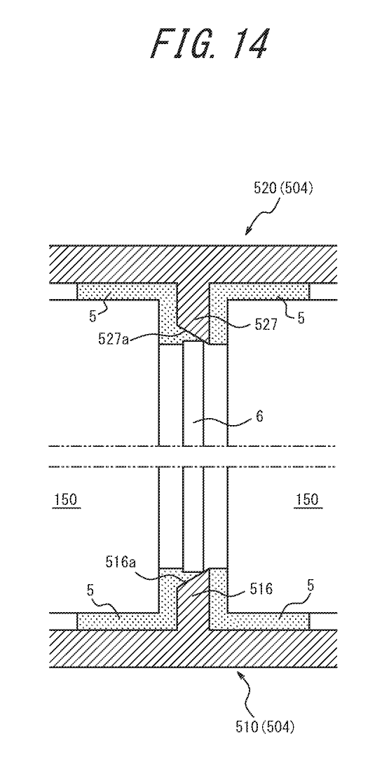

FIG. 14 is a schematic view illustrating another modification of the first frame body and the second frame body in the foregoing embodiment. Specifically, FIG. 14 is a schematic view illustrating the cross-sectional shape of a rib 516 as the first frame body and a rib 527 as the second frame body. A housing 504 illustrated in FIG. 14 includes a lower case 510 and a cell holder 520. As illustrated in FIG. 14, the rib 516 as the first frame body of the lower case 510 differs from the rib 116 in the foregoing embodiment in the cross-sectional shape. Likewise, as illustrated in FIG. 14, the rib 527 as the second frame body of the cell holder 520 differs from the rib 127 in the foregoing embodiment in the cross-sectional shape.

More specifically, a top end surface 516a of the rib 516 as the first frame body and a top end surface 527a of the rib 527 as the second frame body are each a uniform inclined surface that is inclined with respect to the thickness direction of the rib as the frame body, as illustrated in FIG. 14. The top end surface 516a of the rib 516 and the top end surface 527a of the rib 527 illustrated in FIG. 14 are inclined on opposite sides, each with respect to the thickness direction of the rib as the frame body.

As a result of at least one of the top end surface 516a of the rib 516 and the top end surface 527a of the rib 527 being an inclined surface with respect to the thickness direction, the insulation sheet 6 is guided by the inclined surface and approaches one side of the adjacent battery cells 150. At this side, the insulation sheet 6 can be brought into contact with the adhesive portion 5 (FIG. 9) more reliably. The top end surface 516a of the rib 516 is an inclined surface. Accordingly, the height to the top end surface 516a at one end in the thickness direction is less than the height to the top end surface 516a at the other end in the thickness direction (in the example in FIG. 14, the left end of the top end surface 516a is lower than the right end of the top end surface 516a). As a result of the top end surface 516a being lower at one end in the thickness direction in this way, the adhesive as the adhesive portion 5 can easily reach the insulation sheet 6 from this position. This facilitates contact between the adhesive as the adhesive portion 5 and the insulation sheet 6. The same applies to the rib 527.

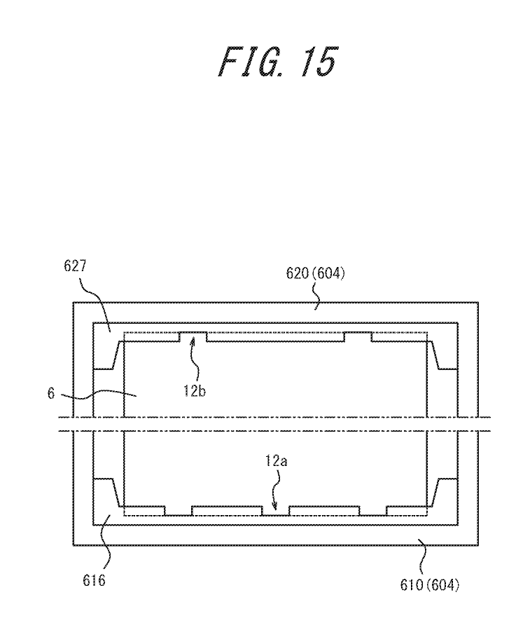

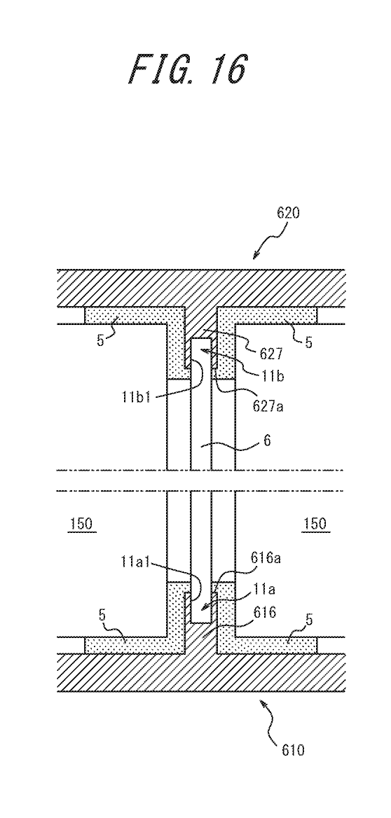

FIG. 15 is a schematic view illustrating yet another modification of the first frame body and the second frame body in the foregoing embodiment. A housing 604 illustrated in FIG. 15 includes a lower case 610 and a cell holder 620. As illustrated in FIG. 15, a rib 616 as the first frame body of the lower case 610 differs from the rib 116 in the foregoing embodiment in the cross-sectional shape. Likewise, as illustrated in FIG. 15, a rib 627 as the second frame body of the cell holder 620 differs from the rib 127 in the foregoing embodiment in the cross-sectional shape. FIG. 16 is a schematic view illustrating the cross-sectional shape of the rib 616 as the first frame body and the rib 627 as the second frame body.

As illustrated in FIG. 16, a housing groove 11a extending in the extension direction of the rib 616 and housing the insulation sheet 6 is formed at a top end surface 616a of the rib 616 as the first frame body. As illustrated in FIG. 16, a housing groove 11b extending in the extension direction of the rib 627 and housing the insulation sheet 6 is formed at a top end surface 627a of the rib 627 as the second frame body.

As a result of forming the housing grooves 11a and 11b for housing the insulation sheet 6 at the end surfaces of the first frame body and the second frame body, the positioning of the insulation sheet 6 can be performed more reliably. In the case where such housing grooves 11a and 11b are provided, there is a possibility that the groove walls defining the housing grooves 11a and 11b hinder the contact of the adhesive as the adhesive portion 5 with the insulation sheet 6. Accordingly, it is preferable to form an opening 12a from the housing groove 11a through to the lateral side of the rib 616 at a groove wall 11a1 defining the housing groove 11a of the rib 616 as the first frame body, as illustrated in FIG. 15. Moreover, it is preferable to form an opening 12b from the housing groove 11b through to the lateral side of the rib 627 at a groove wall 11b 1 defining the housing groove 11b of the rib 627 as the first frame body, as illustrated in FIG. 15. As a result of forming such openings 12a and 12b, the adhesive as the adhesive portion 5 easily enters the housing grooves 11a and 11b through the openings 12a and 12b. This facilitates the contact of the adhesive as the adhesive portion 5 with the insulation sheet 6.

Although the opening 12a is formed in the rib 616 as the first frame body and the opening 12b is formed in the rib 627 as the second frame body in the example illustrated in FIGS. 15 and 16, the opening may be formed in either one of the ribs. In the case where the opening is formed in both of the ribs 616 and 627 as in the example illustrated in FIGS. 15 and 16, however, the insulation sheet 6 can be adhesively fixed more firmly. Although the openings 12a and 12b are groove-shaped openings that are open to the top end surfaces 616a and 627a in the example illustrated in FIGS. 15 and 16, the openings may be hole-shaped openings that are not open to the top end surfaces 616a and 627a.

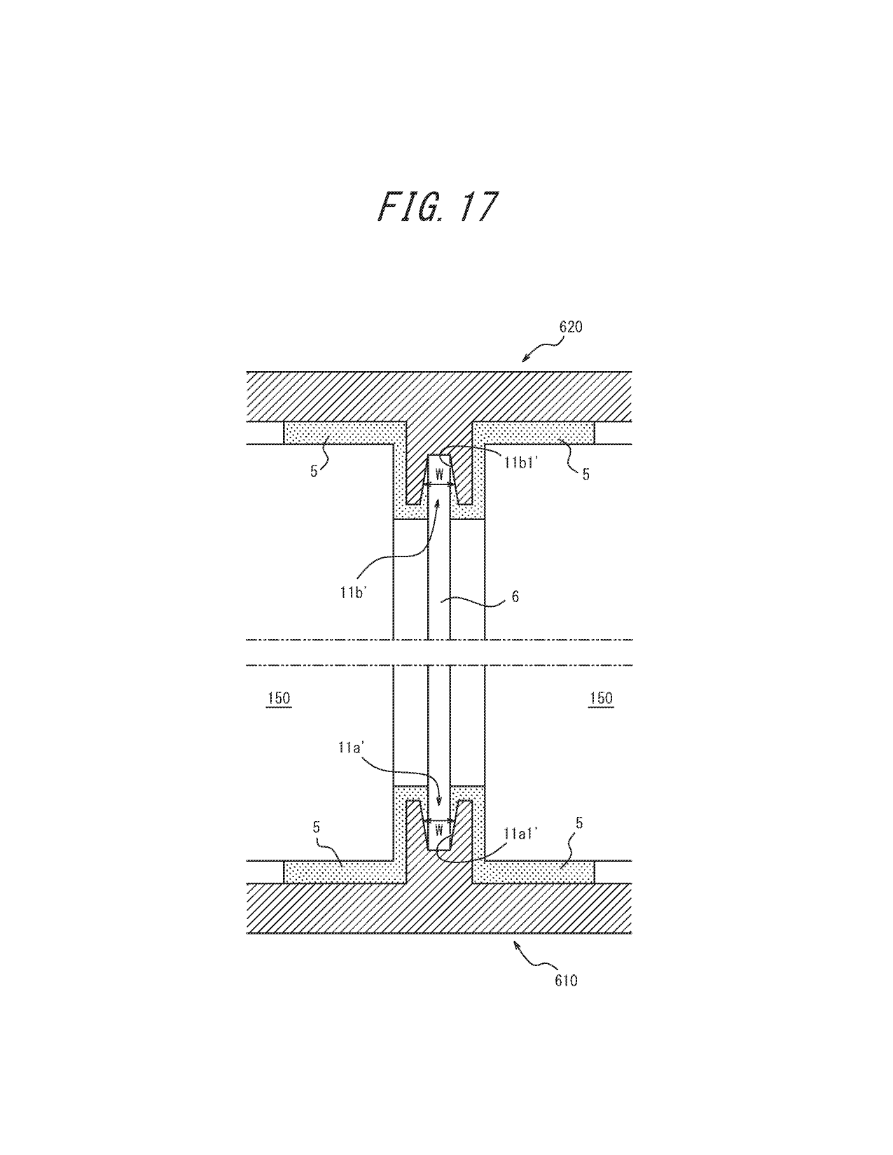

Although the housing grooves 11a and 11b in the example illustrated in FIGS. 15 and 16, are rectangular grooves with a uniform groove width W in the groove depth direction, housing grooves 11a′ and 11b′ defined by groove walls 11a1′ and 11b1′ that gradually decrease in the groove width W toward the groove bottom in the groove depth direction may be used, as illustrated in FIG. 17. As a result of forming such housing grooves 11a′ and 11b′ that gradually decrease in the groove width W toward the groove bottom, the tapered groove walls 11a′ and 11b1′ serve as guide surfaces and easily guide the insulation sheet 6 to the groove bottom. The positioning of the insulation sheet 6 can thus be performed more easily.

The assembled battery according to the present disclosure is not limited to the specific structures illustrated in the foregoing embodiments and modifications, and various changes are possible without departing from the scope of the claims. For example, appropriately combining structures illustrated in the foregoing embodiments and modifications to form another structure is also included in the technical scope of the present disclosure.

### REFERENCE SIGNS LIST

2 battery module
3 auxiliary module
4, 4′, 4″, 504, 604 housing
5 adhesive portion
5a first adhesive portion (holder adhesive portion)
5b second adhesive portion (case adhesive portion)
5c third adhesive portion (holder adhesive portion)
5d fourth adhesive portion (case adhesive portion)
6, 6″ insulation sheet
6a″ projection
7 lower surface of battery cell
8 side surface of battery cell
9a, 9b groove
10a, 10b groove
11a, 11b housing groove
11a1, 11b1 groove wall
12a, 12b opening
15 first housing space
16 second housing space
100 assembled battery
110, 110′, 110″, 510, 610 lower case
110a space
111, 111′ bottom wall
112, 112a, 112b, 112c, 112d, 121a, 121b, 121c, 121d side wall
113, 124a, 124b, 310a, 310b, 310c opening
114 attachment mechanism
115, 129a, 129b engaging hole
116, 116′, 116″, 516, 616 rib (first frame body)
120, 120′, 120″, 520, 620 cell holder
121 outer frame
121e engaging insertion portion
122, 122′ holding lid
122a frame portion
123, 126 screw hole forming portion
123a, 123b, 126a, 163a screw hole
123c bus bar support
125 bead
127, 127′, 127″, 527, 627 rib (second frame body)
128, 205, 320 engaging claw
130 first secondary battery
140 LBC (battery controller)
150 battery cell
151 cap surface of battery cell
152 positive electrode terminal
153 negative electrode terminal
154 safety valve
160 inter-cell bus bar
161 convex portion
162 terminal connector
162a opening for welding
163 voltage sensor attachment terminal
164 total minus terminal bus bar
165 total plus terminal bus bar
166 external connector
166a insertion hole
200 auxiliary pedestal
210 MOSFET
220 relay
230 current sensor
240 fusible link
250 SSG terminal
260 LOAD terminal
270 GND terminal
280, 281, 282, 283, 284 copper bus bar
285 total minus copper bus bar
286 total plus copper bus bar
300 upper case
330 bus bar protector
340, 350 bolt
400 power supply system
410 alternator
420 starter
430 second secondary battery
440 load
450 switch
460 controller
516a, 616a, 527a, 627a top end surface
W groove width

1.-9. (canceled)

10. An assembled battery comprising:
a plurality of battery cells each having a substantially cuboid shape and including: a cap surface provided with a positive electrode terminal and a negative electrode terminal; an opposite surface to the cap surface; and four side surfaces;
an insulation sheet located between the side surfaces of the plurality of battery cells;
a housing for holding the plurality of battery cells, the housing having a first frame body for housing one end side, on one of the cap surface side and the opposite surface side, of each of the plurality of battery cells, and a second frame body for housing the other end side, on one of the cap surface side and the opposite surface side, of each of the plurality of battery cells; and
an adhesive portion being in contact with the insulation sheet, each of the plurality of battery cells, and the housing, for adhering the battery cell to the housing,
wherein, at an end on the one end side of the battery cell, the adhesive portion spreads from between the cap surface or the opposite surface of the battery cell and the first frame body to between an end surface of the insulation sheet and an end surface of the first frame body and to between a part of a surface, in a thickness direction, of the insulation sheet and the side surface of the battery cell, the part of the surface in the thickness direction of the insulation sheet being adjacent to the end surface of the insulation sheet,
wherein the adhesive portion is not in contact with a center portion of the side surface of the battery cell, the center portion located between a cap surface side end and an opposite surface side end on the side surface of the battery cell, and
wherein the adhesive portion is in contact with only at least one of the cap surface side end and the opposite surface side end on the side surface of the battery cell.

11. The assembled battery according to claim 10, wherein at least one of the first frame body, the second frame body, and the insulation sheet includes an adhesion facilitating portion that facilitates contact of the adhesive portion with the insulation sheet.

12. The assembled battery according to claim 11, wherein the adhesion facilitating portion is a groove provided at a side surface of at least one frame body of the first frame body and the second frame body.

13. The assembled battery according to claim 11, wherein the adhesion facilitating portion includes a projection provided on the insulation sheet, and a groove that is provided at an end surface of at least one frame body of the first frame body and the second frame body and into which the projection is fitted.

14. The assembled battery according to claim 10, wherein an end surface of at least one frame body of the first frame body and the second frame body is formed by an inclined surface that is inclined with respect to a thickness direction of the at least one frame body.

15. The assembled battery according to claim 10, wherein a housing groove extending in an extension direction of the first frame body and the second frame body and housing the insulation sheet is formed at an end surface of at least one frame body of the first frame body and the second frame body.

16. The assembled battery according to claim 15, wherein a groove wall defining the housing groove of the at least one frame body of the first frame body and the second frame body has an opening from the housing groove through to a lateral side of the at least one frame body.

17. The assembled battery according to claim 15, wherein the housing groove is defined by a groove wall that gradually decreases in groove width toward a groove bottom in a depth direction.

18. The assembled battery according to claim 10, wherein the housing includes: a lower case including the first frame body defining the plurality of first housing spaces; and a cell holder including the second frame body defining the plurality of second housing spaces,
the adhesive portion includes: a case adhesive portion in contact with the plurality of battery cells and the lower case and adhering the plurality of battery cells to the lower case; and a holder adhesive portion in contact with the plurality of battery cells and the cell holder and adhering the plurality of battery cells to the cell holder, and
the insulation sheet is in contact with at least one of the case adhesive portion and the holder adhesive portion.

19. The assembled battery according to claim 10, wherein the insulation sheet is in contact with a part of the adhesive portion adhering the battery cell to the second frame body of the housing.

20. The assembled battery according to claim 19, wherein the part of the adhesive portion adhering the battery cell to the second frame body of the housing spreads to between the battery cell and the insulation sheet.

21. The assembled battery according to claim 10, wherein the first frame body includes a first rib defining a housing space of the battery cell in the first frame body, and
the adhesive portion adheres a side surface of the first rib to the battery cell, and adheres an upper end of the first rib to the end surface of the insulation sheet.

22. The assembled battery according to claim 21, wherein the second frame body includes a second rib defining a housing space of the battery cell in the second frame body,
the insulation sheet is located between the first rib and the second rib, and
a distance between the first rib and the battery cell between which the adhesive portion is interposed is longer than a distance between the second rib and the battery cell.

23. The assembled battery according to claim 10, wherein the center portion between the cap surface side end and the opposite surface side end on the side surface of the battery cell is apart from the insulation sheet.
